(19) United States
(12) Patent Application Publication
(10) Pub. No.: US 2016/0058057 A1
(43) Pub. Date: Mar. 3, 2016

(54) HAM AND PORCINE PRODUCTS AND PROCESS FOR PREPARING THE SAME

(71) Applicant: Creminelli Fine Meats, LLC, Salt Lake City, UT (US)

(72) Inventors: John Christian Bowler, Salt Lake City, UT (US); Cristiano Creminelli, Salt Lake City, UT (US); Jared Lynch, Salt Lake City, UT (US)

(21) Appl. No.: 14/836,718

(22) Filed: Aug. 26, 2015

Related U.S. Application Data
(60) Provisional application No. 62/042,222, filed on Aug. 26, 2014.

(51) Int. Cl. A23L 1/31; A23L 1/318

(52) U.S. Cl. CPC A23L 1/3103; A23L 1/3182; A23V 2002/00

(57) ABSTRACT

A ham being formed of a single unitary muscle piece from a whole ham leg. The unitary muscle piece is formed in a substantially cylindrical shape with a fat cap extending along, an outer surface the unitary muscle, when formed in the cylindrical shape.

### CROSS-REFERENCE TO RELATED APPLICATIONS

This application claims the benefit of U.S. Provisional Patent Application Ser. No. 62/042,222, filed Aug. 26, 2014, which is hereby incorporated by reference herein in its entirety, including but not limited to those portions that specifically appear hereinafter, the incorporation by reference being made with the following exception: In the event that any portion of the above-referenced application is inconsistent with this application, this application supercedes the above-referenced application.

### BACKGROUND

1. The Field of the Present Disclosure

The present disclosure relates generally to the trimming, forming and other preparations of producing ham and porcine products that can be packaged and delivered to restaurants, retail outlets, or directly to consumers, where such ham or porcine products are seasoned and cooked such that they are ready to eat, alone or in combination with other food products or courses.

2. Background Art

Meat products such as roasts, cooked hams, logs, and the like have traditionally been formed from pieces of meat that are generally prepared by tying the meat together with a cord to form the desired unitary shape, or by pressing the meat together into the unitary shape and cooking the bound pieces until they release the juices containing adhesive proteins that bind the meat together.

It is also traditionally known in the art to prepare pre-sliced canned meats, such as hams, which afford a consumer the convenience of having the ham or meat product already sliced for eating once the container holding the ham or meat product is opened. For example, packaging ham, subsequent to de-boning, de-fatting, and curing, can be molded under pressure in a mold and then cooked at a predetermined temperature. Subsequent to this cooking the juices are poured off and the ham is chilled and then sliced. The chilled ham slices can then be bound with cords or other desired mechanism in order to hold the slices in the proper shape and the bound ham is then placed loosely in a container. The container containing the ham can then be sealed by a known conventional method.

Molded hams, are often formed by molds that are filled with pieces of meat, dried, pressed and then finally cooked. These molds have been made of various shapes, sizes and dimensions. However, having strictly uniform size templates can create unwanted and uneven flavor distribution throughout the meat and can also result in undesirable and uneven dryness of the meat, particularly without the use of additives. Additionally, maintaining strict shape conformity between meat products can influence a consumer to believe that the meat products are over-processed, and include undesirable fillers, and thus inferior in quality and taste.

The features and advantages of the present disclosure will be set forth in the description which follows, and in part will be apparent from the description, or may be learned by the practice of the present disclosure without undue experimentation. The features and advantages of the present disclosure may be realized and obtained by means of the instruments and combinations particularly pointed out herein.

### BRIEF DESCRIPTION OF THE DRAWINGS

The features and advantages of the disclosure will become apparent from a consideration of the subsequent detailed description presented in connection with the accompanying drawings in which:

FIG. 1 is a top perspective view of a ham leg;

FIG. 2 is a bottom view of the ham leg of FIG 1;

FIG. 3 is a fully displayed bottom perspective view of a trimmed ham of the present invention;

FIG. 4 is a partially rolled bottom perspective view of the trimmed ham of FIG. 3;

FIG. 5 is a perspective view of the trimmed ham of FIG. 3. during injection and brining;

FIG. 6 is another perspective view of the trimmed ham of FIG. 3 during injection and brining;

FIG. 7 is a tumbling machine used to tumble the trimmed ham of FIG. 3;

FIG. 8 is a bottom view of the a trimmed ham of the present invention being cut in half, after injection, brining, maceration and tumbling;

FIG. 9 is a perspective view of a half section of the trimmed ham, rolled according to the present invention and prepared to be pressed;

FIG. 10 is the ham of FIG. 9 located in the press chamber of a piston stuffer machine;

FIG. 11 is perspective view of the ham of FIG. 9, on a conveyor after being stuffed by the piston stuffer machine in FIG. 10;

FIG. 12 is the stuffed ham of FIG. 11 on a rack waiting to be cooked;

FIG. 13 is a bottom view of fully prepared rolled ham of the present invention;

FIG. 14 is a side view of the fully prepared rolled ham of FIG. 13;

FIG. 15 is a top view of the fully prepared rolled ham of FIG. 13;

FIG. 16 is a perspective view of a sliced end of the fully prepared rolled ham of FIG. 13; and

FIG. 17 is a side view of multiple slices of the fully prepared rolled ham of FIG. 13.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise.

In describing and claiming the present disclosure, the following terminology will be used in accordance with the definitions set out below.

As used herein, the terms “comprising,” “including,” “containing,” “characterized by,” and grammatical equivalents thereof are inclusive or open-ended terms that do uot exclude additional, unrecited elements or method steps.

Applicant has discovered a novel ham product configuration and a process for preparing said ham, where the ham includes a single unitary muscle, or multiple naturally adjoining groups, never removed from one another or separated, worked as a single muscle, that is rolled on itself such that it forms a generally cylindrical shape having a fat cap that extends over an outer surface of the rolled ham. The generally cylindrical shape of the ham can include a generally rounded outer surface, including: grooves, indentations and/or other imperfections, and the longitudinal length of the ham is significantly greater that the thickness and/or diameter of the ham. The present disclosure can also be referenced to as a “single primal cut” of meat such as the leg/ham which is made up of the five muscle groups. As known in the art, a structure such as that described herein can be referred to as a bulk protein structure since protein comprises a primary component of the product.

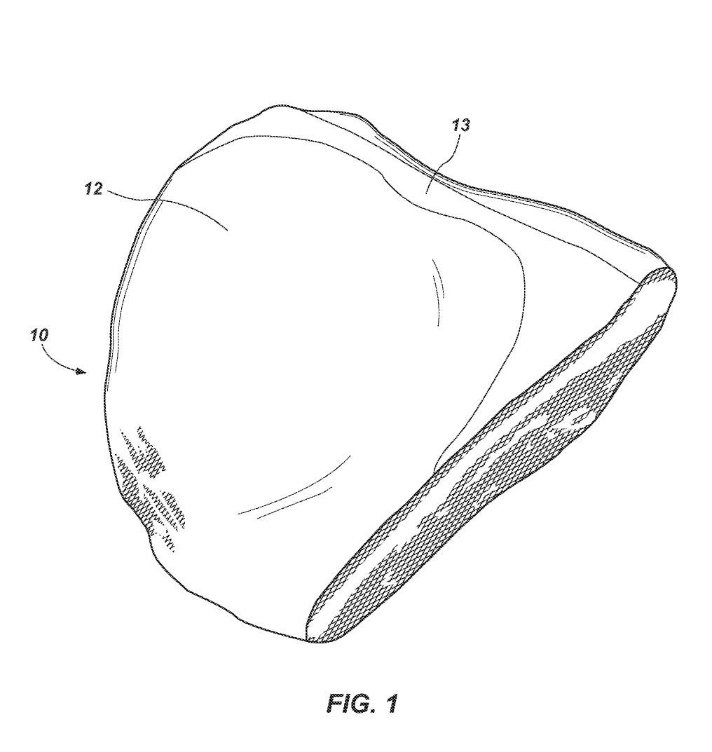

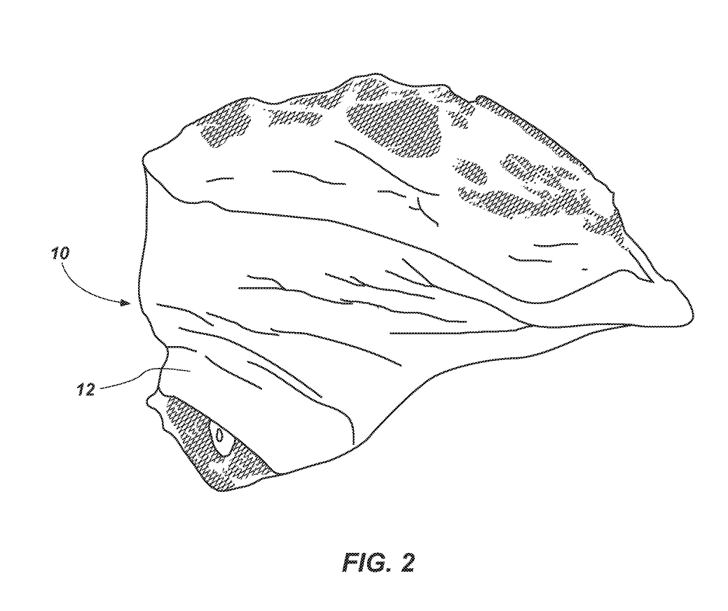

FIGS. 1 and 2 illustrates a whole bone-in, skin on, ham leg 10. The shank has already been removed ham leg 10, with the whole bone-in thigh portion remaining with the skin 12 still in tact. The ham leg 10 is then ready to be trimmed.

The ham leg is trimmed by removing all skin 12, bones, cartilage and periosteum that attached to the ham leg 10. Subcutaneous fat that exists between the skin and the meat of the ham leg 10 is called a fat cap 13. According to the present disclosure, the fat cap 13 that is attached to the remaining ham leg 10 portion, after the skin 12 is removed, is trimmed to the desired fat cap 13 thickness, typically no more than ¼ inch over the exterior surface of the ham, however, in alternative embodiments a fat cap 13 may also have a thickness greater than ¼ inch. This remaining fat cap 13 on the exterior surface of the trimmed ham 18 may cover between about 25% and about 75% of the surface area of the ham leg 10. There are also alternative embodiments of the trimmed ham 18, where the fat cap 13 covers more that about 75% or less than about 25% of the surface area of the trimmed ham 10.

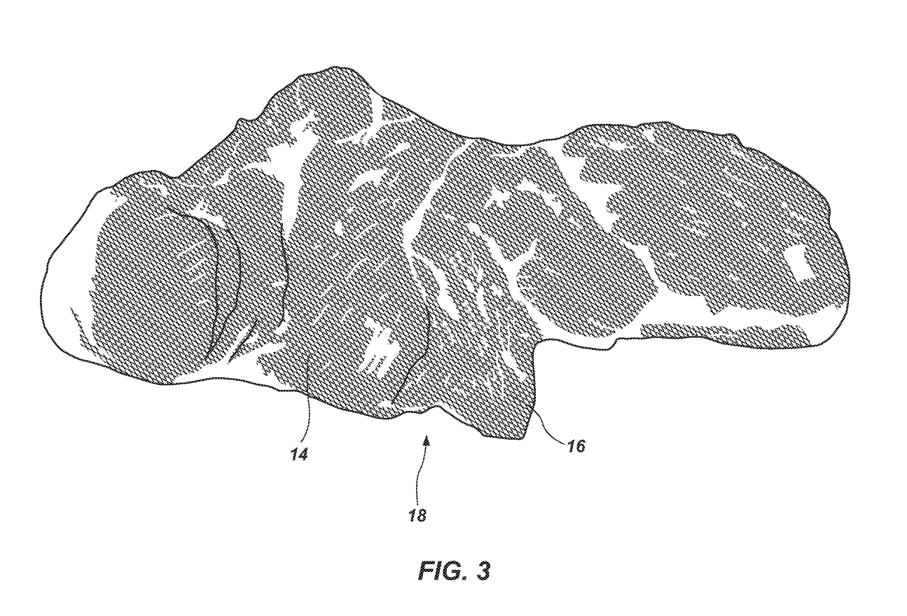

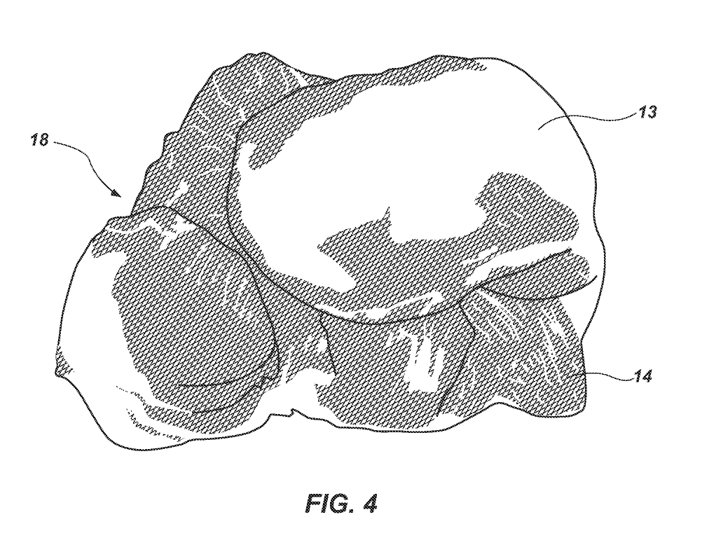

The ham leg 10 includes a dark butt portion (not shown in the drawings) and a light butt portion 14, as shown in FIGS. 3 and 4. The dark butt portion is trimmed away and removed from the ham leg 10, leaving only the light butt portion 14. Any loose or clumped fat attached to the ham leg 10 is trimmed and removed. Fat that is attached to an interior side 16 of the trimmed ham 18 is trimmed down to the lean muscle, otherwise know as “trimmed to the blue.” All protruding tendons and tendon tips are also removed. Finally, all bruises and blood spots greater than one (1) inch are preferably trimmed and removed, resulting in a fully trimmed ham 18.

As shown in FIGS. 3 and 4, the trimmed ham 18 is a single unitary whole muscle piece. Conventional ham products often include multiple pieces that have been previously separated and often combined with other muscle pieces from other ham legs, and the multiple muscle pieces are bound together to form a finished ham product. However, as shown in the exemplary embodiment of FIGS. 3 and 4, a single whole muscle piece (trimmed ham 18), including multiple naturally occurring adjoining intact muscle groups (never separated), inherently communicates to a potential customer that “filler” was not added to the ham during preparation and that the ham, in its entirety, is one ham from one animal and not pieced together from multiple animals, thus providing a higher quality ham product.

FIG. 4 shows the trimmed ham 18 partially rolled over onto itself to show the fat cap 13 that is left intact on the exterior surface of the trimmed ham 18.

After trimming of the ham 18 is complete, the ham 18 can be brined. The brine can be used to season the ham 18 and can include various seasonings, depending on the desired flavor of ham, water or other desired additives. The brining can also vary in concentration, for example, the brine concentration used in one embodiment of the present disclosure could range from about 5% to about 15%, or alternative embodiments may include brine concentrations that may exceed about 15% or be less than about 5%, depending on the desired flavor intensity or other preferences.

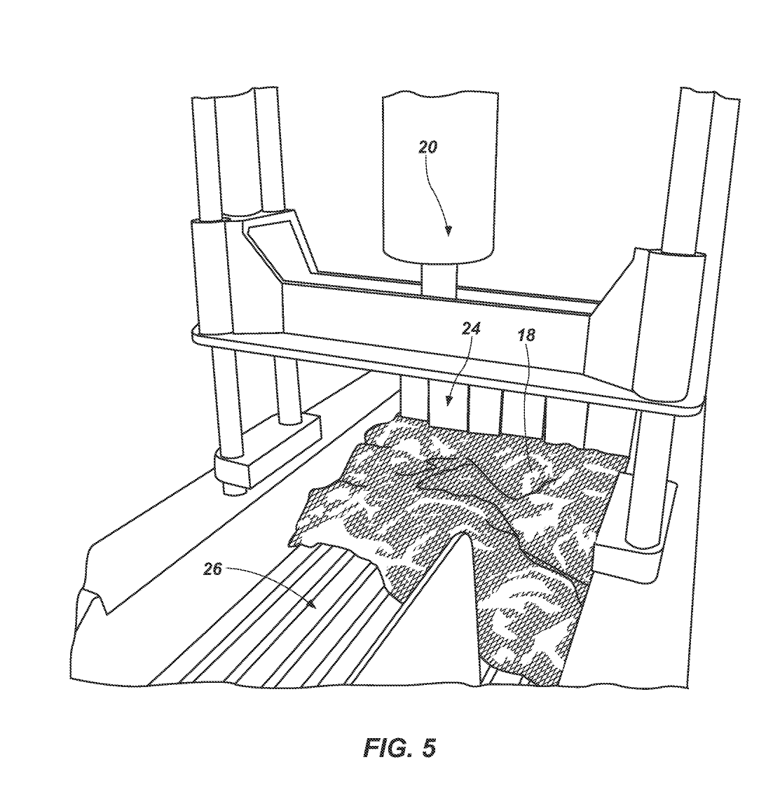

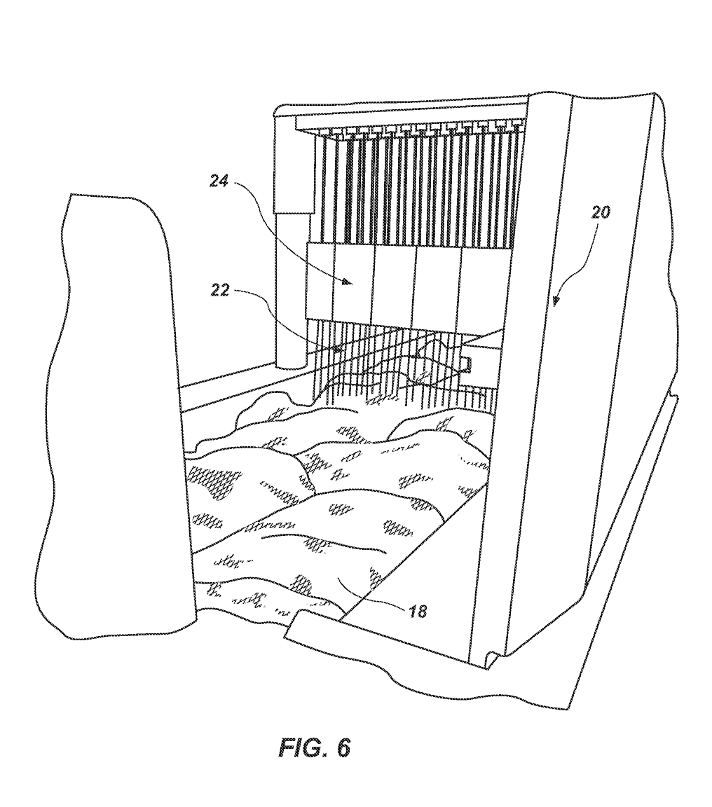

As shown in FIGS. 5 and 6, the ham 18 can be brined via a brining machine 20 that includes a series of needles 22 fixed to a needle block 24. During this brining process, the ham 18 is moved along a conveyor 26 and as the ham 18 passes under the needle block 24, the needles 22 penetrate the muscle tissue of the ham 18. As the needles penetrate the ham 18, a brine solution is pumped through the needles 22, directly into the muscle of the ham 18. This brining process enables the seasoning of the brine to be better incorporated into muscle tissue of the ham 18.

Alternative brining methods can also be used to prepare the ham 18. For example, the ham may be brined by basting the ham 18 with the brine solution, or a spray gun or alternative spraying device can be used to saturate the ham 18 with the brining solution. The ham 18 could also be soaked or submerged in the brine solution for a desired period of time, which could enable the brine solution to penetrate into the muscle tissue of the ham 18.

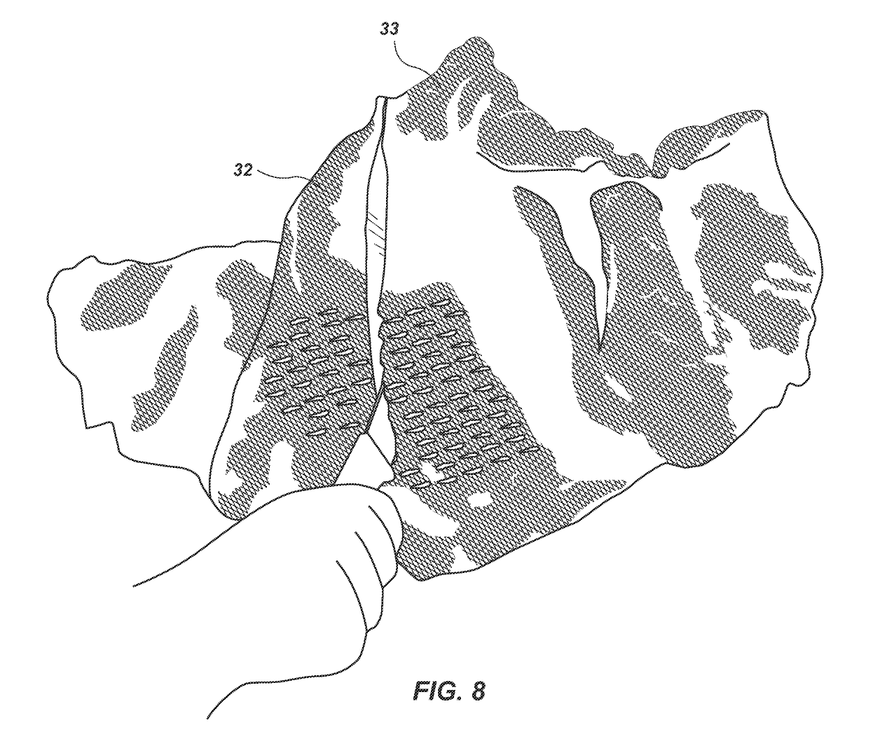

After applying the brining solution to the ham 18, the ham 18 is macerated, which creates a series of substantially superficial cuts 19 (the cuts 19 are more clearly seen in FIG. 8) into the interior surface of the ham 18. Maceration of the ham 18 can serve multiple benefits, such as, tenderization of the ham 18 and improved absorption of the brine into the muscle of the ham 18.

Maceration of ham and other meats commonly occurs on two opposite sides of a piece of meat, however, in the disclosed embodiment, maceration only takes place on the interior surface of the ham 18 in order to preserve the appearance and integrity of the fat cap 13, which provides not only a desired appearance of the finished ham product, but also improves the quality and taste of the ham 18 by ensuring a desired and concentrated fat content.

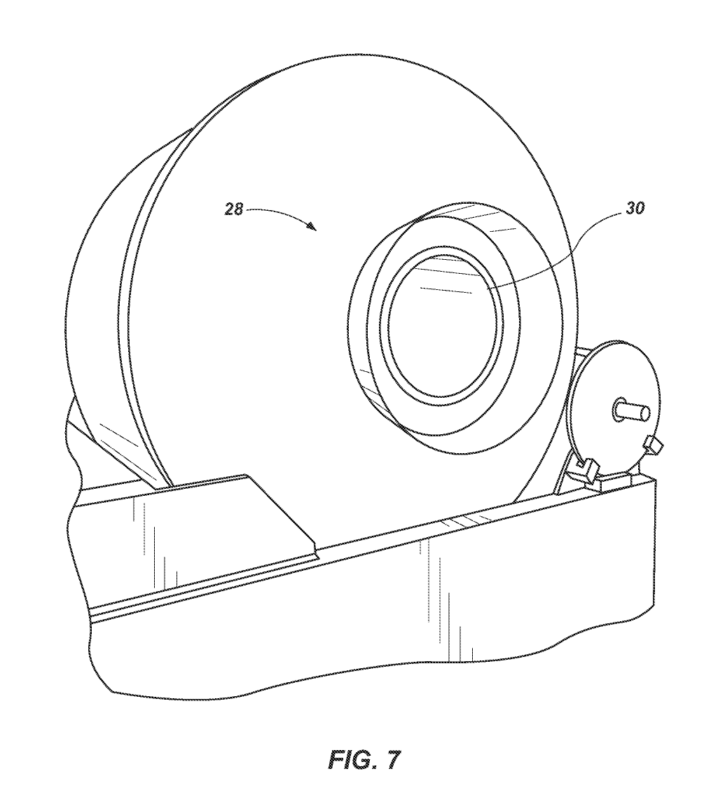

After maceration of the ham 18 is completed, the ham 18 can be further tenderized in a tumbling machine 28 (shown in FIG. 7), such as a vacuum tumbler, for example. The ham 18 is placed within the tumbling machine 28 through an entry port 30. The interior of the tumbling machine 28 is then continuously rotated, thereby causing the ham 18 to tumble over itself and against an interior surface of the tumbling machine 28. Tumbling of the ham 18 can occur for any desired amount of time. Tumbling of the ham 18 further tenderizes the ham 18 and improves incorporation of the brine and any other seasonings into the muscle of the ham 18. Alternative tenderizing method can also be used instead of, or in addition to, use of the tumbling machine 28, for example, the ham can be manually hit, or via automation, with a tenderizing mallet or other mechanism that could be used to tenderize the ham.

Once tumbling of the ham 18 is completed, the ham 18 is removed and bisected, as shown in FIG. 8. The two resulting pieces 32 and 33 of the ham 18 are substantially equal in weight and surface area, thus creating a desired amount of uniformity, although not identical, between ham pieces 32 and 33. Also note, FIG. 8 clearly shows the superficial cuts caused during maceration of the ham 18. While an embodiment of the present disclosure includes bisecting the ham 18, it is also contemplated that the ham 18 could be further processed as a single piece without being cut at all, or alternatively, the ham could also be cut into more than two pieces.

After the ham 18 has been bisected, each of the two ham sections 32 and 33 will complete the remaining process steps until each section 32 and 33 forms individual finished rolled ham products.

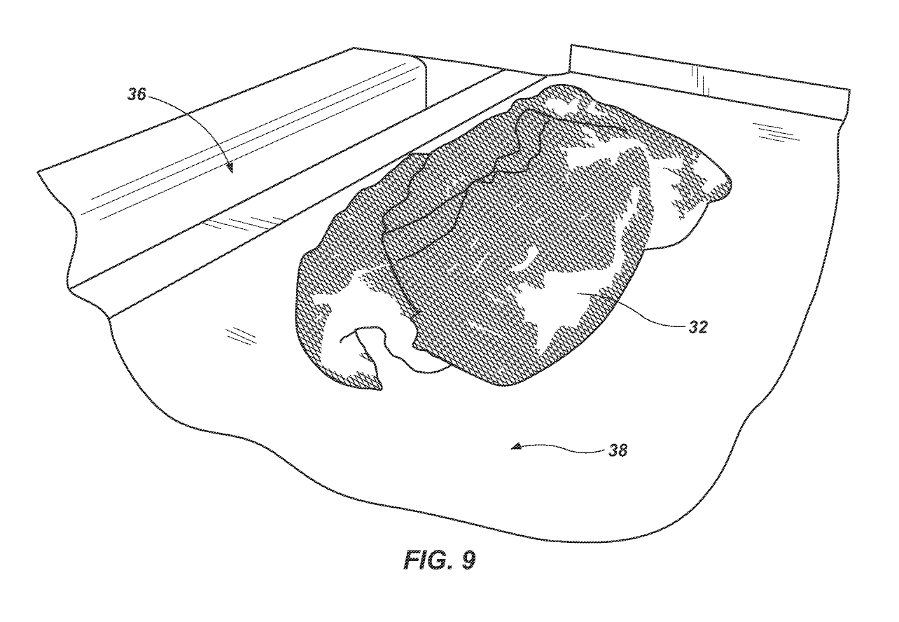

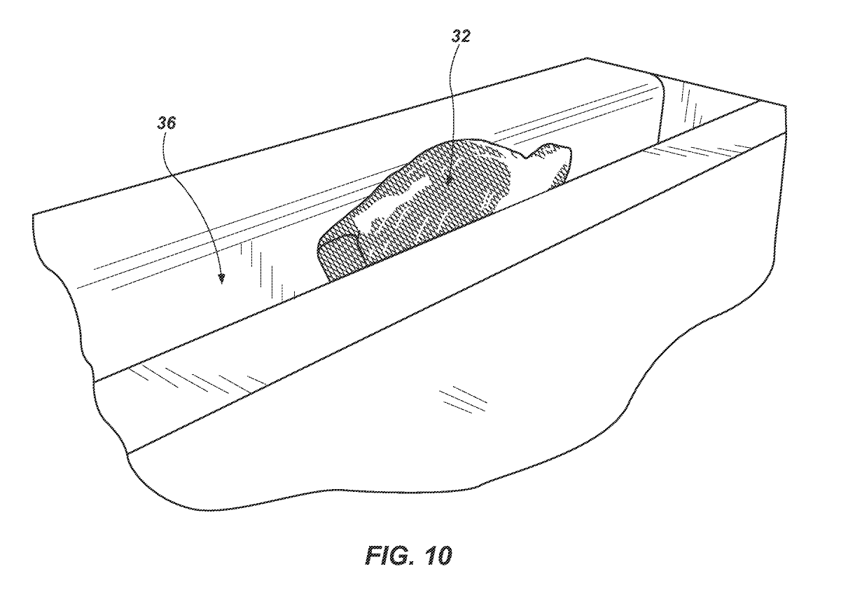

As shown in FIGS. 9 and 10, ham section 32 is rolled onto itself to form a cylinder-like shape, such that the exterior surface of the rolled ham section 32 has the fat cap 13 remaining on the exterior surface of the cylinder-like shape. Once the ham section 32 is rolled, the ham 32 is placed in a trough 36 of a piston stuffer machine 38. After the ham section 32 is placed in the trough 36, a top press member (not shown) compresses the ham section 32 until the ham section 32 tightly conforms to the shape of the trough 36, which is substantially cylindrical in shape.

Once the ham section 32 has been pressed, a piston (not shown) pushes along the longitudinal axis of the trough 36, which in turn pushes the ham 32, and the piston continues pushing the ham 32 until the ham 32 is pushed through an opening at the end of the trough 36. As the pressed ham 32 passes through the opening in the trough 36, a netting 40, or sock, is forced over the entire exterior surface of the ham 32.

Traditionally hams are pressed and/or stuffed using a funnel stuffer which receives ham pieces vertically into a large funnel and then presses and extrudes processed hams horizontally out of an extrusion port. However, this type of press and stuffer is not efficient to produce the ham of the present disclosure because the rolled and pressed ham 32 must have the fat cap 13 on the exterior surface of the ham 32 to preserve the desired appearance and flavor distribution of the ham 32. This desirable orientation of the ham is preferably not accomplished via a funnel stuffer. Thus the use of the piston stuffer 38 is very desirable in forming of the ham 32 of the present disclosure.

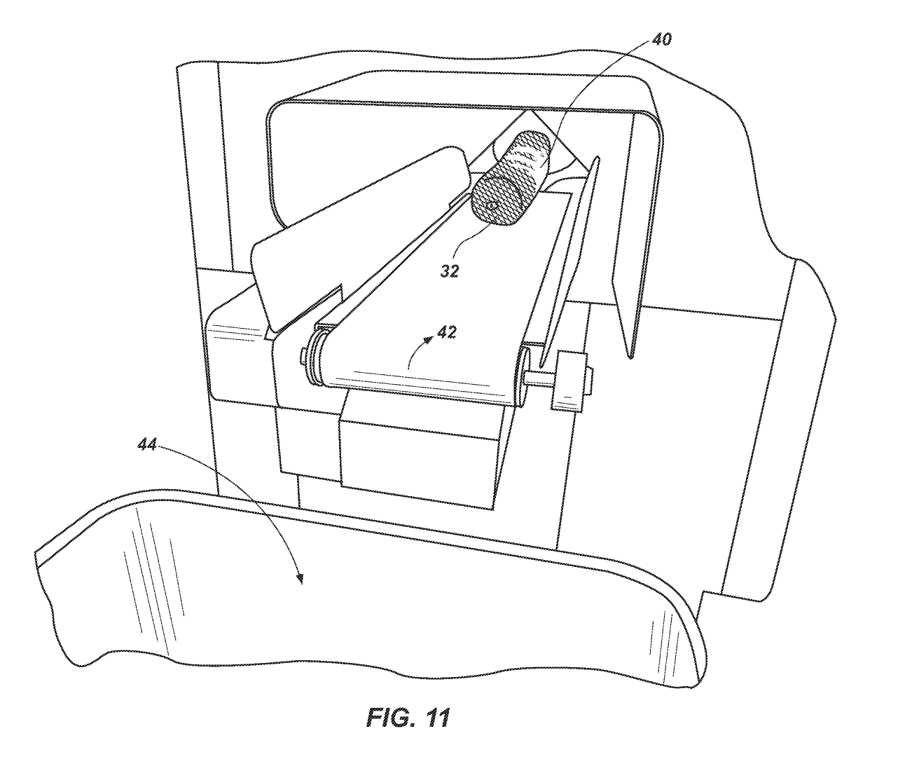

As shown in FIG. 11, the ham 32, after receiving the netting 40, is moved along a conveyor 42 until it is dropped or placed into a container 44. The netting 40 is used to keep the pressed ham 32 in its cylindrical shape during cooking and cooling.

Often ham products include a casing that forces the ham to take a desired shape, however, these types of casings often result in very uniform, if not exact and unnatural, shape conformity between ham products. This type of shape conformity can compress the ham more than is desirable resulting in unwanted flavor distribution throughout the ham and can also result in excessive dryness of the ham. Additionally strict shape uniformity between ham products can communicate or influence a consumer to believe that the ham product is heavily processed and unnatural, and thus, of lower quality and inferior taste.

In contrast, the rolled and pressed ham 32 of the present disclosure, preserves a uniqueness in shape between finished ham products, although still generally cylindrical in shape. This “uniqueness” can convey to a consumer that the ham 32 is a whole muscle ham product, also including a whole primal cut (as described above), derived from a single unitary muscle piece, indicating higher quality and better taste of the ham 32.

After the ham 32 has been pressed and stuffed into the netting 40, the ham 32 is placed on a rack 42 which is then placed into an oven to be cooked. The ham 32 can be cooked for any desired amount of time and at a desired temperature. In an embodiment of the present disclosure the ham may be cooked at atemperature between about 135 degrees F. and about 175 degrees F. However, alternative embodiments may cook the ham at faster or slower cook times which would influence the necessary cook temperature. Thus, in alternative embodiments, the ham 32 may be cooked at temperatures greater than about 175 degrees F. or less than about 1350 degrees F.

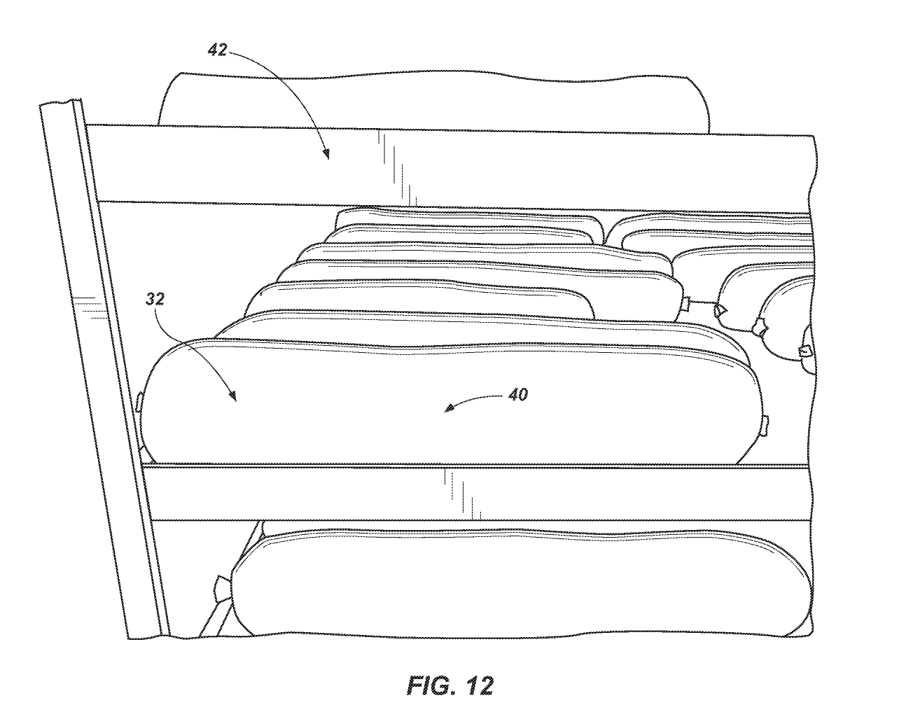

Once the ham 32 has been cooked, the rack 42 can be removed from the oven and is desirably placed in a chiller or refrigerator, as shown in FIG. 12, where the ham 32 is then “blast chilled” or cooled by some other desired method known in the art. After the ham 32 has been sufficiently chilled, the netting 40 can be removed and the finished rolled ham 32 can be packed for sale and/or transport.

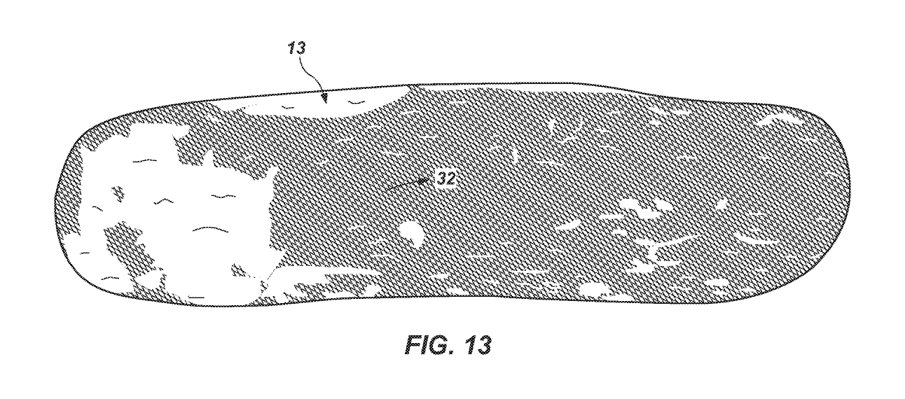

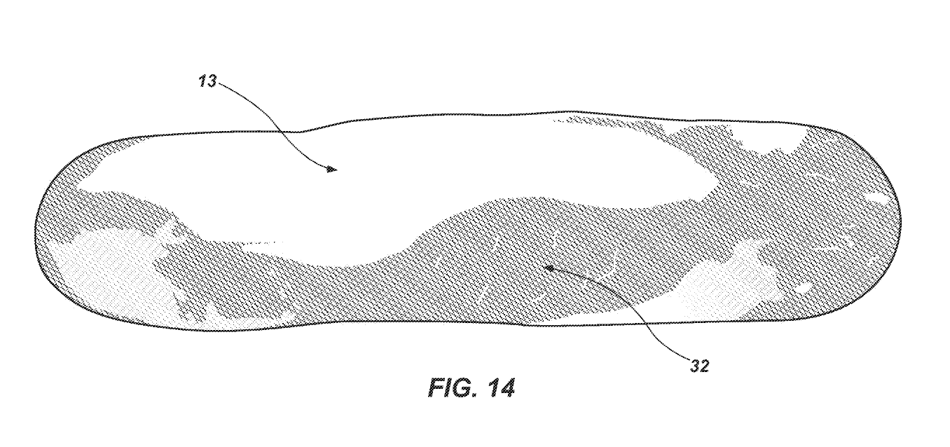

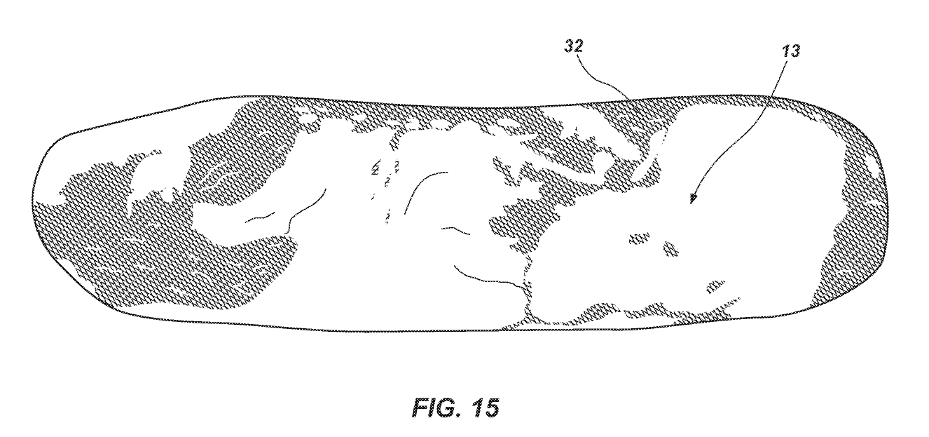

FIGS. 13-15 show the finished rolled ham 32 ready for consumption. Particularly, FIGS. 13-15 show how the fat cap remains on the exterior surface of the ham 32 and that the fat cap 13 maintains a substantially elongated shape that extends longitudinally and substantially parallel with the longitudinal axis of the ham 32.

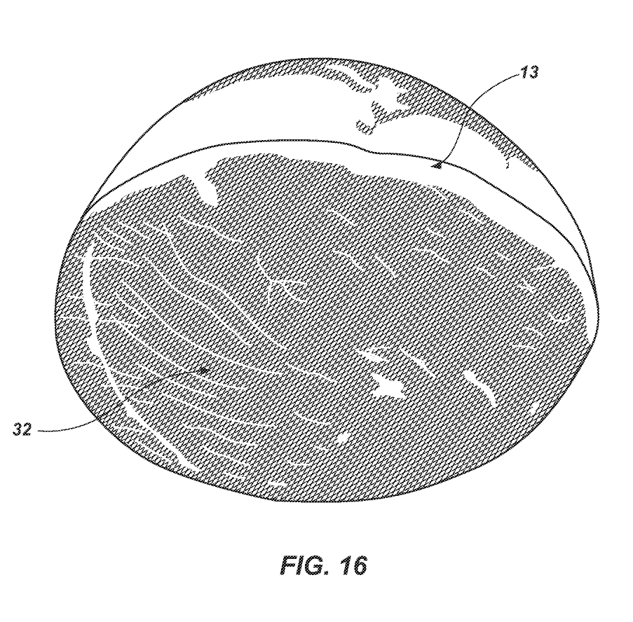

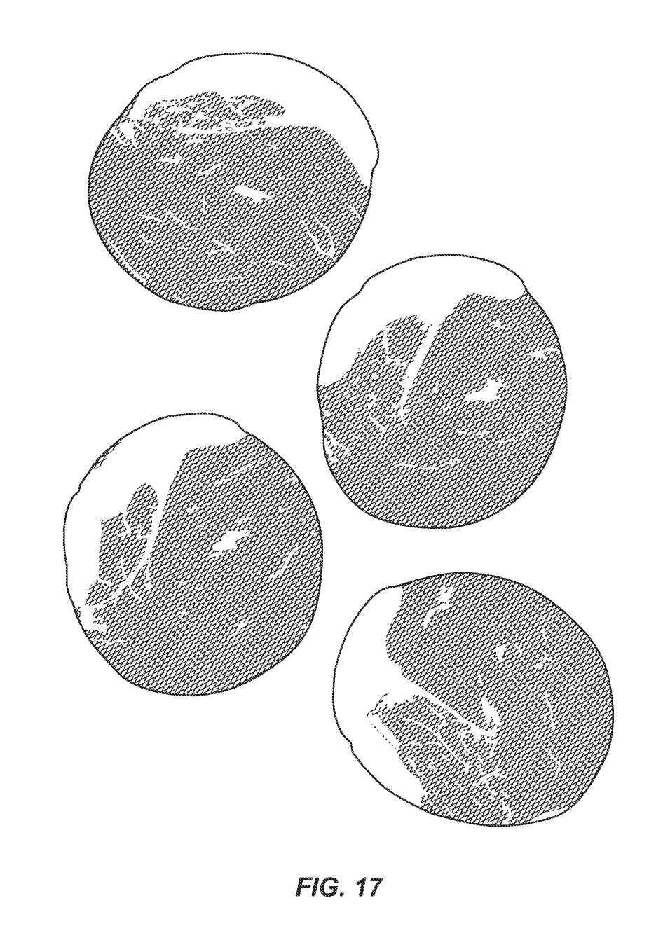

FIGS. 16 and 17 show cross-sectional slices of the ham 32. These cross-sectional slices show that there is very little fat within the interior of the ham 32, being formed entirely of the light butt portion 14 of the ham leg 10, which is very lean. Thus the majority of the fat is present on the exterior surface of the ham 32 in the fat cap 13. The slices also show the substantially uniform location and size of the fat cap 13. The size and orientation of the fat cap 13, approximately ¼ inch thick (covering approximately about 25% to about 75% of the surface area of the ham 32) and located on a limited section of the exterior surface of the ham 32, preserves the desired appearance and flavor distribution characterized by the all natural and high quality components of the ham 32.

Beyond the shape and composition of the finished rolled ham 32, the size and dimensions are also important in facilitating more efficient use of the ham 32. By way of example and not by limitation, the width or diameter of a cross-section of the ham 32 can be within the range of about 3.5 to about 4.5 inches with a target length of about 4 inches, and the longitudinal length of the ham 32 can be within the range of about 15 to about 19 inches, with a target length of about 17 inches. However, alternative embodiments of the present disclosure may include rolled ham sizes that are smaller or larger than those disclosed above. Additionally, the weight of the finished rolled ham 32 can be within the range of about 6 to about 7 pounds, with a preferred target weight of about 6.5 pounds. Alternative ham embodiments have also been contemplated that may exceed the disclosed weight range or weigh less than about 6 pounds, depending on other desired factors, including the size of the ham. The disclosed size and weight ranges, and target sizes, make the ham 32 of the present disclosure an ideal size for slicing, as it is generally compatible with the size restrictions of many meat slicing machines. The size of the resulting slice can also be ideal for various cooking applications, such as sandwiches, for example.

It is to be understood that the above-described arrangements are only illustrative of the application of the principles of the present disclosure. Numerous modifications and alternative arrangements may be devised by those skilled in the art without departing from the spirit and scope of the present disclosure are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed:

1. A ham comprising:
a cut of meat selected from the group consisting essentially of: a single unitary muscle piece from a whole ham leg or a primal piece consisting of five adjoining muscle groups from a whole ham leg;
said unitary muscle piece being formed in a generally cylindrical shape; and
a fat cap extending along an outer surface the unitary muscle when formed in the cylindrical shape.

2. The ham of claim 1, wherein the majority of the fat present in the ham is located on the outer surface of the unitary muscle when formed in the cylindrical shape.

3. The ham of claim 1, wherein the cut of meat includes only one muscle piece.

4. The ham of claim 1, wherein the cut of meat does not include a casing.

5. The ham of claim 1, wherein the diameter of the ham is between about 3.5 inches and about 4.5 inches.

6. The ham of claim 1, wherein the ham is boneless.

7. The ham of claim 1, wherein the longitudinal length of the ham in between about 15 and about 19 inches.

8. The ham of claim 1, wherein the fat cap covers about 25% to about 75% of the outer surface area of the ham.

9. The ham of claim 1, herein the fat cap is approximately ¼ inch thick.

10. The ham of claim 1, wherein the generally cylindrical shape includes: a generally rounded outer surface.

11. The ham of claim 1, wherein the generally cylindrical shape includes: a longitudinal length of the ham that is significantly greater than a diameter of the ham.

12. The process of preparing a ham including:
trimming a whole ham leg such that the bone and skin are removed, and a single unitary muscle piece remains;
applying a brining solution to the muscle piece;
rolling the muscle piece into a generally cylindrical shape such that a fat cap extends over an outer surface of the cylindrical shape; and
pressing the muscle piece.

13. The process of claim 12, further comprising macerating only one surface of the muscle piece.

14. The process of claim 12, further comprising tenderizing the muscle piece after applying the brining solution to the muscle piece.

15. The process of claim 14, wherein the tenderizing of the muscle piece includes:
tumbling the muscle piece.

16. The process of claim 12, further comprising cooking the first muscle piece while the muscle piece remains within the netting.

17. The process of claim 16, wherein the entire fat cap remains on the exterior of the muscle piece after pressing, stuffing and cooking the muscle piece.

18. The process of claim 17, wherein the fat cap covers between about 25% and about 75% of the surface area of the ham.

19. The process of claim 12, wherein the applying of the brining solution to the muscle piece includes:
injecting the brining solution into the muscle piece.

20. The process of claim 12, further comprising:
bisecting the muscle piece after the applying of the brining solution to the muscle piece, forming a first muscle piece and a second muscle piece.

21. The process of claim 12, further comprising:
stuffing the muscle piece into a netting after the muscle piece has been pressed.

22. The process of claim 12, wherein the generally cylindrical shape includes: a generally rounded outer surface.

23. The process of claim 12, wherein the generally cylindrical shape includes: a longitudinal length of the ham that is significantly greater than a diameter of the ham.

24. The process of claim 12, wherein the brining solution has a concentration range of 5% to 15%.

25. The process of claim 12, further comprising: cooking the muscle piece at a temperature between 135 degrees Fahrenheit and 175 degrees Fahrenheit, after the pressing of the muscle piece.

26. A ham comprising:
a single unitary piece of meat;
said single unitary piece of meat being rolled into a generally cylindrical shape; and,
a fat cap extending along an outer surface the single unitary piece of meat when formed in the cylindrical shape, such that the fat cap covers between about 25% and about 75% of an exterior surface of the ham.

27. The ham of claim 26, wherein the majority of the fat present in the ham is located on the outer surface of the unitary muscle when formed in the cylindrical shape.

28. The ham of claim 26, wherein the single unitary piece of meat is not combined with any other pieces of meat to form the ham.

29. The ham of claim 26, wherein the single unitary piece of meat does not include a casing.

30. The ham of claim 26, wherein the diameter of the ham is between about 3.5 inches and about 4.5 inches.

31. The ham of claim 26, wherein the ham is boneless.

32. The ham of claim 26, wherein the longitudinal length of the ham in between about 15 and about 19 inches.

33. The ham of claim 26, wherein the fat cap is approximately ¼ inch thick.

34. The ham of claim 26, wherein the single unitary piece of meat includes, five adjoining muscle groups from a whole ham leg.

35. The ham of claim 26, wherein the generally cylindrical shape includes: a generally rounded outer surface.

36. The ham of claim 26, wherein the generally cylindrical shape includes: a longitudinal length of the ham that is significantly greater than a diameter of the ham.

37. A bulk protein structure comprising:
a naturally occurring unitary muscle piece;
said unitary muscle piece being formed in a generally cylindrical shape; and
an amount of fat extending along an outer surface of the unitary muscle when formed in the cylindrical shape.

38. The bulk protein structure of claim 37 wherein the naturally occurring unitary muscle piece consists essentially of a whole ham leg or a primal piece consisting of five adjoining muscle groups from a whole porcine leg.

39. The bulk protein structure of claim 38 wherein the amount of fat comprises a fat pad and wherein the fat pad is located on the outer surface of the unitary muscle when formed in the cylindrical shape.

40. The bulk protein structure of claim 39, wherein the unitary muscle piece comprises only one muscle piece.

41. The bulk protein structure of claim 40, wherein the unitary muscle piece is without a casing.

42. The bulk protein structure of claim 41, wherein the diameter of the bulk protein structure is between about 3.5 inches and about 4.5 inches.

43. The bulk protein structure of claim 42, wherein the unitary muscle structure is a boneless ham.

44. The bulk protein structure of claim 43, wherein the longitudinal length of the bulk protein structure is between about 15 and about 19 inches.

45. The bulk protein structure of claim 44, wherein the fat cap covers about 25% to about 75% of the outer surface area of the bulk protein structure.

46. The bulk protein structure of claim 45, wherein the fat cap is approximately ¼ inch thick.

47. The bulk protein structure of claim 46, wherein the generally cylindrical shape is a generally rounded outer surface.

48. The bulk protein structure of claim 46, wherein the generally cylindrical shape includes a longitudinal length bulk protein structure that is significantly greater than a diameter of the bulk protein structure.

49. An edible product formed by a process comprising the steps of:
trimming a porcine leg such that the bone and skin are removed, and a single unitary muscle piece remains;
applying a brining solution to the muscle piece;
rolling the muscle piece into a generally cylindrical shape such that an amount of extends over an outer surface of the cylindrical shape; and
compressing the muscle piece.

50. The product of claim 49, further comprising the step of macerating only one surface of the muscle piece.

51. The product of claim 49, further comprising the step of tenderizing the muscle piece after applying the brining solution to the muscle piece.

52. The product of claim 49, wherein the step of tenderizing of the muscle piece comprises tumbling the muscle piece.

53. The product of claim 49, further comprising the step of cooking the muscle piece while the muscle piece remains within a netting.

54. The product of claim 49, wherein the amount of fat comprises a fat cap and the entire fat cap remains on the exterior of the muscle piece further comprising the steps of pressing, stuffing and cooking the muscle piece.

55. The product of claim 54, wherein the fat cap covers between about 25% and about 75% of the surface area.

56. The product of claim 49, wherein the step of applying the brining solution to the muscle piece comprises injecting the brining solution into the muscle piece.

57. The product of claim 56, further comprising the step of bisecting the muscle piece after the applying of the brining solution to the muscle piece, forming a first muscle piece and a second muscle piece.

58. The product of claim 57, further comprising the step of stuffing the muscle piece into a netting after the muscle piece has been pressed.

59. The product of claim 49, wherein the generally cylindrical shape includes a generally rounded outer surface and wherein the edible product is a ham having a longitudinal length which is significantly greater than a diameter of the ham.

60. The product of claim 59, wherein the brining solution has a concentration range of about 5% to about 15%.

61. The product of claim 59, further comprising the steps of:
pressing of the muscle piece; and,
cooking the muscle piece at a temperature between 135 degrees Fahrenheit and 175 degrees Fahrenheit.
